(19) United States
(12) Patent Application Publication
(10) Pub. No.: US 2020/0287741 A1
(43) Pub. Date: Sep. 10, 2020

(54) Method of Scheduling an Appliance Service Call Using an IOT Device

(71) Applicant: Michael L. Ritter, JR., South Bend, IN (US)

(72) Inventor: Michael L. Ritter, JR., South Bend, IN (US)

(21) Appl. No.: 16/295,188

(22) Filed: Mar. 7, 2019

(51) Int. Cl. H04L 12/28; H04L 29/08; G06Q 10/00; F24F 11/32

(52) U.S. Cl. CPC H04L 12/2825; H04L 12/282; F24F 11/32; G06Q 10/20; H04L 67/125

(57) ABSTRACT

HVAC service scheduling method using an IOT device connected to a computing device that is operable in different modes. The first mode corresponds to the user needing immediate service, the second mode corresponds to the user needing maintenance, and the third mode corresponds to the user needing to be contacted. The modes are chosen by the types of presses on a button on the IOT device. When the button is pressed in the first or second mode, the IOT device contacts a scheduling service that proposes a time for a service technician, based on a qualified technician's schedule. The user confirms the time via push notifications sent to the user's mobile device, fixing the time in the technician's schedule. When the button is pressed in the third mode, a customer concierge contacts the user based on preferences set by the user.

### BACKGROUND OF THE INVENTION

This present disclosure relates to appliance service call scheduling for household devices, such as furnaces, air conditioning, heat pumps, or other HVAC components that are attached to or incorporated into a structure. Routine and preventive maintenance, emergency repairs, and troubleshooting require some sort of service call by a qualified and trained professional. With HVAC components, little to no thought is given to its operation until a problem arises. Some HVAC components can operate for years without needing any repairs, while others require frequent repairs or maintenance. For the average homeowner, scheduling a service call by a trained HVAC professional involves contacting one through a phone book, the internet, discussing with a neighbor, or remembering an advertisement they recently saw. If the homeowner calls different professionals each time, the new provider has to determine any previous repairs and educate themselves as to the state of the equipment, resulting in lost time, wasted resources, and increased downtime. Some providers add decals to the equipment as a handy way to find out which provider to contact, but these are subject to becoming outdated, damaged, or illegible. An improved method of scheduling HVAC maintenance and repair is needed.

### SUMMARY OF THE INVENTION

The present disclosure describes a method of scheduling a service call by a service provider using an IOT device that connects to the internet directly or through a computer or smartphone. The IOT device is linked to a customer account at a service provider that retains customer-specific information in a database, such as location, type of equipment, payment information, and other relevant information specific to that account and user. When the user presses the button on the IOT device, the device communicates with an application that automatically checks availability of technicians qualified to service or repair the customer-specific equipment. Based on how the user presses the button on the IOT device, the parent application will prioritize the type of call. The user may enable the high priority call, where the equipment is in need of immediate repair, a low priority mode where maintenance or cleaning is needed, or the user may desire a phone call or email. The application interacts with the user to schedule or reschedule the appointment.

### BRIEF DESCRIPTION OF THE DRAWINGS

FIG. 1 is an overall view of the components at the customer and at the service provider; and

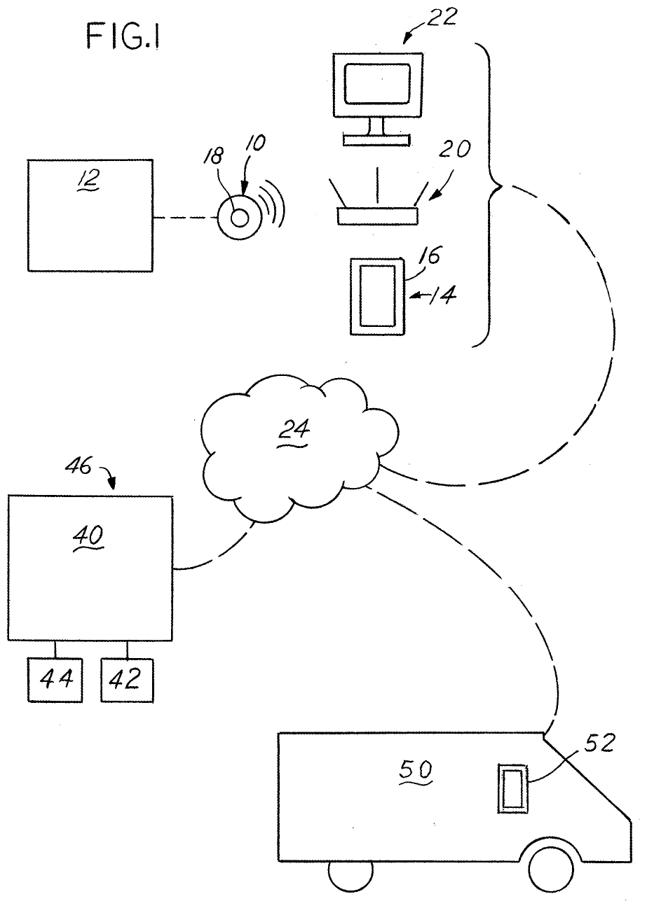

FIG. 2 is a flow diagram of the steps that occur when the customer activates the IOT button.

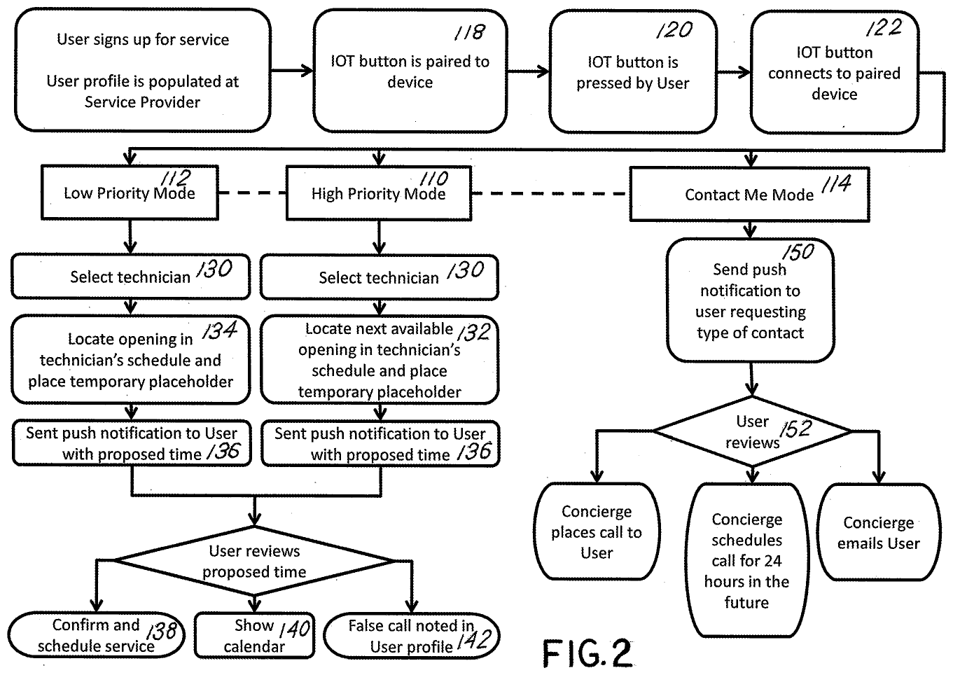

### DESCRIPTION OF THE PREFERRED EMBODIMENT

The method described herein uses a standalone IOT (Internet-Of-Things) device 10 to schedule a service call, contact, or maintenance for HVAC (Heating, Ventilation, Air Conditioning) equipment 12. The method and system has the following components: an IOT device 10, a technician, a user, a mobile application 14, a parent application 40, and a human concierge 42. The HVAC equipment 12 is installed at a dwelling, building, or other structure. The user is defined as the person that operates the IOT device 10 and will need HVAC maintenance. The technician 50 is the person that has the skill set to repair and maintain the HVAC equipment and can travel to the user's location, and the human concierge 42 is the person that will perform supervisory functions at the service provider 46. The mobile application 14 is installed on the user's mobile device 16 and is used to provide information and schedule functions. The parent application is used at the service provider 46 to interact with the mobile application, user, human concierge 42, and technician 50. Each of these components will be described further below.

The IOT device is affixed to the structure, directly onto the HVAC equipment or controls, or some other location convenient to the user. The IOT device may either be self-powered, plugged into a nearby outlet, or receive power from the HVAC equipment. The IOT device has at least one input button 18 that is readily accessible to the user, and will commonly have a primary input button and sometimes one secondary button (for pairing or other features). If the device is self-powered, it will have an internal battery that is commonly user-replaceable. The TOT device, in order to be connected to the internet 24, uses Bluetooth, Wi-Fi router 20, or proprietary communication in conjunction with a smart home hub (not shown). Bluetooth, Wi-Fi, and smart home hub communication protocols are well-known in the art. The TOT device 10 may connect through at least one of these protocols to a user's smartphone 14, tablet, computer 22, or other device with internet access. The user may pair the device themselves or the service provider 46 or technician 50 may pair the device to aid the user.

As previously disclosed, the TOT device is typically affixed to or located in the structure with HVAC equipment 12 for the user to have easy access to the button. The TOT device may be affixed to the wall adjacent HVAC controls, such as a thermostat or humidistat. The TOT device 10 has a unique serial number, code, or other identifier, so that when it communicates with the service provider over the internet, the software, application, or user on the provider's end can associate that particular TOT device with an account in the parent application. Each TOT device 10 is associated with a user account in a database 44 with detailed information about the user, including a street address for the HVAC equipment, billing information, contact information, mobile phone number, discount club participation, email address, preferences, scheduling conflicts, security access codes, service and repair history, and any other relevant information the user or provider may require to gain access to service the HVAC equipment.

Along with accounts for each user, the service provider has multiple technicians 50, each having different skill sets and areas of expertise. Each technician will have unique information stored at the service provider that is related to their skill sets, areas of expertise, repair history, and a calendar. For example, some technicians are qualified to work on complex commercial refrigeration units, while others may have a lower skill level and can only work on simpler devices, such as a residential electric heating unit. Each technician may have a mobile device 52 that is used to receive notifications and scheduling information. The mobile device 52 could be in the form of a two-way radio, cell phone, or tablet. Optionally, the mobile device will have a technician application or calendar that interacts with the provider. The technician's mobile device may monitor current geographic location to give the provider or parent application information about technician's whereabouts.

A human concierge 42 resides at the service provider. The service provider described herein is commonly the main business location where inventory is stored, vehicle dispatch occurs, records are kept, and billing and payment occurs. However, this is not required. The human concierge 42 can be remote or off-site. The concierge provides some managerial decision-making authority for the service provider and serves as a customer contact. The concierge interacts with the parent application to approve changes, update the database, and provide other supervisory functions. The concierge may also intervene to override appointment times or calendar events in the event a customer or technician cannot make the scheduled time and does not use the mobile application to communicate the change.

The IOT device remains in a standby mode and is only activated when the user presses the button. The button may be pressed in one of 3 ways: 1) a single short press of the button when the customer has a need for a repair on their system; 2) a rapid double pressing when the customer wants to schedule routine maintenance; or 3) a semi-long holding press when they would like the provider to contact them and answer question(s). The first type of press activates a high-priority mode, the second type of press activates a low-priority mode, and the third type of press activates a contact-me mode. The types of presses described herein are for the purposes of defining different types of button presses and this disclosure is not limited to the types of presses being associated with the types of services requested. For example, instead of calling for repair, a single short press could be assigned to the function where the provider contacts them to answer questions. Other types of presses not described specifically herein may also be incorporated to request additional services, one example being a long press followed by a short press.

Pressing the button on the IOT device wakes it from a sleep mode. It then connects to the device in which it is paired to communicate the type of press. For a Wi-Fi connected device, the IOT device initiates communication to the parent application directly over the internet. For a Bluetooth connected device, it will communicate with the device to which it is paired, activating the mobile application on that device. The mobile device is defined as a smartphone, tablet, or other device that is connected to the internet. This could include a laptop or desktop computer. The mobile application then communicates over the internet to the parent application. At that point, the Bluetooth paired device with the mobile application transmits to the parent application at the service provider the desired mode along with the unique identifier. For both types of connected devices, the parent application retrieves the user account information from the database. For users that have a mobile device, the parent application will then communicate with the mobile application on the customer's mobile device. For other users, the human concierge will be notified of the user information and type of press. Communication at the TOT device may be one-way, in that no immediate acknowledgement is provided to the customer. Alternatively, the TOT device may provide visual, audible, or other indication that it has made contact with the parent application.

A mobile application is installed on the user's mobile device, such as smartphone or tablet. It provides information about the status of the TOT device, recent button presses, and allows the customer to communicate with the parent application and customer concierge. The mobile application allows the customer to perform all of the same functions as the TOT device but also allows the customer to provide further detail about any issues they are having with the HVAC equipment, such as providing pictures or video. The mobile application allows the customer to further describe any problems or questions they may have. The mobile application can be used to schedule, cancel, and/or reschedule appointments.

When the user activates the TOT device in high priority mode, the parent application reviews availability of service technicians, assesses the skill level required based on the equipment information in the user account, their geographical location, and any preferences. The parent application selects from all technicians a qualified technician, depending on the HVAC equipment recorded in the user account. Alternatively, the human concierge selects a technician. The parent application then reviews calendars of all qualified technicians and places a temporary place marker in the next available timeslot in the chosen technician's calendar. Technicians are chosen based upon geographic location and earliest available time. The parent application sends a message with the proposed time for the service call to the customer's mobile device through the mobile application or text message. At this point in time, the time is unconfirmed and no firm service is scheduled. The customer will have to respond to the text message or notification through the mobile application with one of 3 answers: 1) Yes, that day and time is acceptable. If this is done, the temporary marker becomes a fixed scheduled appointment. 2) No, that day and or time is not acceptable; please provide other schedule options. If this is chosen, the parent application will provide other schedule options. The customer will be given various other options to choose from, and when chosen, the process will follow that of 1) above. 3) Please do not send anyone out; the button press was accidental. If this is chosen, the temporary marker is removed and the process ends with a note being placed in the file of a false call. False calls are tracked in order to improve communication and teaching on the use of the button if a customer has a lot of false calls.

When the user activates the TOT device in low priority mode (i.e. a rapid double pressing), it will connect to the parent application the same way as in high priority mode where it sends information to the parent application. The parent application looks at availability of service technicians, assesses the skill level required based on the equipment information (if any) on file for them, and their geographical location. It will put a temporary place marker for the customer in the appropriate technician's available time slot in the scheduling software for some time in the next fourteen (14) days. A text message, push notification, or alert will be sent to the customer's mobile device or phone number provided at time of originally setting up the button. This message will require them to respond with one of 3 answers as described in the high-priority mode. The primary difference between low priority mode and high priority mode is related to the prioritization of calendar and availability of time slots. The high priority chooses a first-available slot, while lower priority chooses a slot that is some time in the next fourteen days.

When the user activates the TOT device in “contact me” mode, (a semi long holding press) the TOT device will send information to the parent application that will then give them a push notification through the mobile application or text message asking them the following: 1) Please call me ASAP—if this is chosen, a follow up message will be sent with basic liability disclaimer language in case it is a REAL emergency such as a fire, CO poisoning, etc.; 2) Please call me within the next 24 hours; or 3) Please email me within the next 24 hours.

Regardless of which is chosen, the parent application will send an email and notification to the Customer Concierge with the relevant customer's information and preferences tied to their account in the database.

In some situations, the customer will press the button on the IOT device and not respond to the push notification, message, or SMS. This results in temporary schedule placeholders/markers in the calendar, along with unconfirmed requests for contact. Temporary placeholders pollute the calendar and prevent others from scheduling service or maintenance calls. For temporary placeholders/markers that are not confirmed, the customers will receive communication from the parent application, concierge, dispatcher, or push notification to follow up on any unconfirmed appointments. Failure to respond will result in the temporary placeholder/marker to be removed.

Optionally, a dispatcher or customer concierge will look at all calls that are marked as holding a temporary placeholder but not solidly scheduled near the beginning and end of their work time. Any temporary placeholder that is still unconfirmed in the next 2 business days, the customer concierge will begin to attempt to contact the customer(s) via the customers preferred method of communication and exhaust their efforts by attempting all methods on file except mailing which will be determined on a case by case scenario. This will be done in an attempt to make sure all customers are contacted even if they no longer have the device they originally had linked to the IOT button such as if they upgraded to a new smart phone or have a new cell number.

Anytime the IOT button is pressed and a push notification is sent (typically via text message), the notification will have a link and recommendation for them to download the mobile application. This way they will be able to schedule a service call, maintenance, or request a call even if they are not able to activate the IOT button. Alternatively, the notification will only provide the link to download the mobile application the first time.

It is understood that while certain aspects of the disclosed subject matter have been shown and described, the disclosed subject matter is not limited thereto and encompasses various other embodiments and aspects. No specific limitation with respect to the specific embodiments disclosed herein is intended or should be inferred. Modifications may be made to the disclosed subject matter as set forth in the following claims.

What is claimed is:

1. A method for a user to schedule a service call for HVAC equipment using an IOT device, said method comprising:
providing an IOT button with a unique ID, said IOT button capable of pairing and communicating with an internet-connected device;
pairing said IOT button to said internet-connected device;
activating said IOT button to communicate with said internet-connected device in one of three modes, a first mode being a high-priority mode, a second mode being a low-priority mode, and a third mode being a contact-me mode;
said IOT button communicating said unique ID and said mode to a parent application through said internet-connected device;
said parent application locating information about said user's HVAC equipment using said unique ID;
placing a temporary marker in a scheduling calendar if said first mode or said second mode is activated, said temporary marker including a proposed time for said service call, contacting said user of said temporary marker through a push notification;
notifying a customer concierge if said third mode is activated, contacting said user through said push notification requesting further information from said user; and
said parent application selecting a technician and a placing a temporary date placeholder in said technician's calendar.

2. The method of claim 1, further comprising the step of said user confirming said temporary marker if said first mode or said second mode is activated, said temporary marker becoming a scheduled time.

3. The method of claim 1, further comprising said temporary marker being a first available time if said first mode is activated, if said second mode is activated said temporary marker being any available time up to 14 days after said second mode is activated.

4. The method of claim 1, wherein said parent application purging said temporary markers not confirmed by said user after a predetermined period of time.

5. The method of claim 1, further providing a mobile application, said mobile application for said user to confirm said temporary markers.

6. The method of claim 1, wherein said further information requested of said user consisting of said user's desired method of further communication.

7. A method for a user to schedule a service call for HVAC equipment over the internet, said method comprising:
pairing an IOT button to an internet-connected device;
activating said IOT button to communicate with said internet-connected device in one of two modes, a first mode being a high-priority mode, a second mode being a low-priority mode;
said IOT button communicating a unique ID and said mode to a parent application through said internet-connected device;
placing a temporary marker in a scheduling calendar if said first mode or said second mode is activated, said temporary marker including a proposed time for said service call, notifying said user of said temporary marker through a push notification;
said temporary marker being a first available time if said first mode is activated, if said second mode is activated said temporary marker being any available time up to 14 days after said second mode is activated; and
said parent application selecting a technician and a placing said temporary date placeholder in said technician's calendar.

8. The method of claim 7, further comprising the step of said user confirming said temporary marker if said first mode or said second mode is activated, said temporary marker becoming a scheduled time.

9. The method of claim 7, wherein said parent application purging said temporary markers not confirmed by said user after a predetermined period of time.

10. The method of claim 7, further providing a mobile application, said mobile application for said user to confirm said temporary markers.

11. The method of claim 7, wherein said parent application locating information about said user's HVAC equipment using said unique ID, said parent application selecting a qualified technician.

12. The method of claim 7, wherein said IOT button has a third mode being a contact-me mode, notifying a customer concierge if said third mode is activated, contacting said user through a push notification requesting further information from said user, said further information requested of said user consisting of said user's desired method of further communication.

13. A method of scheduling service for HVAC equipment over the internet comprising:
pairing an IOT device to an internet-connected device at a customer;
associating said IOT device to a corresponding customer account at a service provider;
when said customer activates said IOT device, said device contacts said service provider over the internet, said service provider selects a qualified technician and reviews said qualified technician's calendar to locate available times to schedule said service, said service provider selects one of said available times and contacts said customer through a push notification to set said temporary placeholder in a calendar at said service provider;
if said customer responds to said push notification and agrees to said available time, said temporary placeholder becomes a permanent placeholder;
if said customer responds to said push notification and rejects said available time, said service provider responds with alternate available times.

14. The method of claim 13, wherein said IOT device activates in a high priority mode and a low priority mode, in said low priority mode, said service provider selects said available time within fourteen days, in said high priority mode, said service provider selects a first said available time.

15. The method of claim 14, wherein said TOT device activates in a contact-me mode, said service provider contacts a customer concierge to contact said customer.

16. The method of claim 13, wherein said TOT device connects to said internet over Wi-Fi.

17. The method of claim 13, wherein said push notification from said service provider is through an application on a mobile device at said customer.

18. The method of claim 13, wherein said TOT device has a contact-me mode, said contact-me mode notifying a customer concierge and contacting said user through said push notification requesting further information from said user, said further information requested of said user consisting of said user's desired method of further communication.
